(19) United States
(12) Patent Application Publication
(10) Pub. No.: US 2015/0262555 A1
(43) Pub. Date: Sep. 17, 2015

(54) DISPLAY APPARATUS AMD METHOD OF DRIVING DISPLAY APPARATUS

(71) Applicant: SAMSUNG ELECTRONICS CO., LTD., Suwon-si (KR)

(72) Inventor: Jeong-shan NA, Hwaseong-si (KR)

(73) Assignee: SAMSUNG ELECTRONICS CO., LTD., Suwon-si (KR)

(21) Appl. No.: 14/536,810

(22) Filed: Nov. 10, 2014

(30) Foreign Application Priority Data
Mar. 17, 2014 (KR) 10-2014-0031026

(51) Int. Cl. G09G 5/18

(52) U.S. Cl. CPC G09G 5/18; G09G 2330/02

(57) ABSTRACT

A display apparatus and a method of driving the display apparatus are provided. The display apparatus includes: a display panel including a plurality of source lines and a plurality of gate lines; a sensor configured to sense a leakage current of at least one source line of the plurality of source lines or at least one gate line of the plurality of gate lines; and a driver configured to, in response to the sensed leakage current being higher than or equal to a preset value, control an amount of power supplied to the line, from which the leakage current higher than or equal to the preset value is sensed, to drive the display panel.

### CROSS-REFERENCE TO RELATED APPLICATION(S)

This application claims priority under 35 U.S.C. §119 from Korean Patent Application No. 10-2014-0031026, filed on Mar. 17, 2014, in the Korean Intellectual Property Office, the disclosure of which is incorporated herein by reference in its entirety.

### BACKGROUND

1. Field

The present general inventive concept generally relates to providing a display apparatus and a method of driving the display apparatus, and more particularly, to providing a display apparatus that prevents a degradation phenomenon of a display panel and a method of driving the display apparatus.

2. Description of the Related Art

A display apparatus such as a TV is an electronic device that selects a broadcast signal from broadcast signals transmitted from a broadcasting station through a channel selected by a user, demodulates the broadcast signal to separate a voice and an image from each other, processes the separated voice and image, and outputs the processed voice and image through a display panel or a speaker. In general, examples of display apparatuses that are most widely used include various types of display apparatuses such as a liquid crystal display (LCD), a plasma display panel (PDP), an organic light-emitting diode (OLED), a cathode-ray tube, etc.

If a display apparatus displays an image for a long time, an afterimage remains in a particular area of a display panel or a degradation phenomenon of a display screen occurs. In particular, if the display apparatus continuously displays one image for a long time, an afterimage remains in an area in which the image is displayed.

According to an existing art, the display apparatus performs a refreshing operation with respect to the degraded display screen for a preset off-time to remove a display degradation phenomenon.

However, if it is impossible to perform the refreshing operation for an off-time of the display panel according to a use environment of the display apparatus, a degradation of the display apparatus becomes more serious.

### SUMMARY

Exemplary embodiments address at least the above problems and/or disadvantages and other disadvantages not described above. Also, exemplary embodiments are not required to overcome the disadvantages described above, and an exemplary embodiment may not overcome any of the problems described above.

One or more exemplary embodiments provide a display apparatus that senses a leakage current of each line of the display apparatus to perform a refreshing operation with respect to a pixel line on which a screen degradation occurs when a screen is driven, and a method of driving the display apparatus.

According to an aspect of one or more exemplary embodiments, there is provided a display apparatus including: a display panel including a plurality of source lines and a plurality of gate lines; a sensor configured to sense a leakage current of at least one source line of the plurality of source lines or at least one gate line of the plurality of gate lines; and a driver configured to, in response to the sensed leakage current being sensed through the sensor and being higher than or equal to a preset value, control an amount of power supplied to the line, from which the leakage current higher than or equal to the preset value is sensed, to drive the display panel.

The display apparatus may further include a timing controller configured to control a display time of the display panel. The driver may determine a blanking interval at which an image is not displayed on the display panel when the display panel is driven through the timing controller and control the amount of power supplied to the line at the blanking interval.

In response to the leakage current of the at least one line being higher than or equal to the preset value, the driver may determine a degradation characteristic of the display panel according to an amount of the sensed leakage current.

The leakage current may indicate a display degradation characteristic of a white pattern when the amount of the leakage current is large and indicate a display degradation characteristic of a black pattern when the amount of the leakage current is small.

The driver may increase the amount of power supplied to the at least one line in response to the at least one line indicating the display degradation characteristic of the white pattern and decrease the amount of power supplied to the at least one line in response to the at least one line indicating the display degradation characteristic of the black pattern.

The sensor may sense the leakage current by sensing variations in a current of the at least one source line of the plurality of source lines or the at least one gate line of the plurality of gate lines.

In response to the sensed leakage current being lower than the preset value, the driver may determine that the display panel is normal.

The driver may be configured to control the amount of power supplied to the line, from which the leakage current higher than or equal to the preset value is sensed, to refresh the display panel.

The driver may be further configured to control the amount of power supplied to the line to refresh the display panel during a blanking interval.

According to another aspect of one or more exemplary embodiments, there is provided a method of driving a display apparatus including a plurality of source lines and a plurality of gate lines. The method may include: sensing a leakage current of at least one source line of the plurality of source lines and at least one gate line of the plurality of gate lines; and in response to the sensed leakage current being higher than or equal to a preset value, controlling an amount of power supplied to the line, from which the leakage current higher than or equal to the preset value is sensed, to drive a display panel.

A blanking interval, at which an image is not displayed on the display panel when the display panel is driven through a timing controller, may be determined, and the amount of power supplied to the line may be controlled at the blanking interval.

The driving of the display panel may include: in response to the sensed leakage current being higher than or equal to the preset value, determining a degradation characteristic of the display panel according to an amount of the sensed leakage current.

The leakage current may indicate a display degradation characteristic of a white pattern when the amount of the leakage current is large and indicate a display degradation characteristic of a black pattern when the amount of the leakage current is small.

The driving of the display panel may include: in response to the at least one line indicating the display degradation characteristic of the white pattern, increasing the amount of power supplied to the at least one line, and in response to the at least one line indicating the display degradation characteristic of the black pattern, decreasing the amount of power supplied to the at least one line.

The sensing the leakage current may include sensing variations in a current of the at least one source of the plurality of source lines or the at least one gate line of the plurality of gate lines.

Determining, in response to the sensed leakage current being sensed through the sensor and being lower than the preset value, the display panel as being normal.

The controlling an amount of power supplied to the line, from which the leakage current higher than or equal to the preset value is sensed, may include controlling a refreshing of the display panel.

The controlling the refreshing of the display panel may occur during a blanking interval.

According to an aspect of one or more exemplary embodiments, there is provided a display apparatus including: a display panel including one or more source lines and one or more of gate lines; a sensor configured to sense a leakage current of the source line and a leakage current of the gate line; and a driver configured to, in response to the sensor sensing a leakage current higher than a preset value from sensed line among the source line and the gate line, refresh the sensed line.

The sensor may include a first sensor configured to sense a leakage current of the source line and a second sensor configured to sense a leakage current of the gate line.

The driver may be further configured to determine a blanking interval of the display panel and refresh the sensed line during the blanking interval

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a simple structure of a display apparatus according to an exemplary embodiment;

FIG. 2 is a view illustrating a detailed structure of a display apparatus, according to another exemplary embodiment;

FIG. 3 is a view illustrating a blanking interval according to an exemplary embodiment; and

FIG. 4 is a flowchart illustrating a method of driving a display apparatus according to an exemplary embodiment.

### DETAILED DESCRIPTION OF THE EXEMPLARY EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

Although the terms first, second, etc. may be used herein to describe various elements, these elements should not be limited by these terms. These terms are only used to distinguish one element from another element.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “includes,” “including,” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

In exemplary embodiments, a “module” or a “unit” may perform at least one function or operation and may be embodied as hardware or software or as a combination of hardware and software. Also, a plurality of “modules” or a plurality of “units” may be integrated into at least one module and may be embodied as a particular hardware, such as at least one processor (not shown).

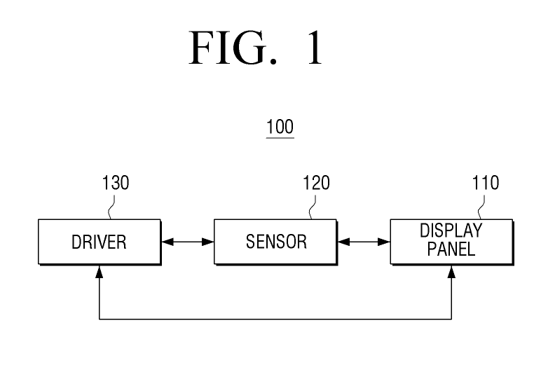

FIG. 1 is a block diagram illustrating a simple structure of a display apparatus 100 according to an exemplary embodiment. Referring to FIG. 1, the display apparatus 100 includes a display panel 110, a sensor 120, and a driver 130. Here, the display apparatus 100 may be realized as a liquid crystal display (LCD) display apparatus, but this is only an exemplary embodiment. The display apparatus 100 may be realized as another type of display apparatus such as, as non-limiting examples, a plasma display panel (PDP), a cathode-ray tube (CRT), an organic light-emitting diode (OLED), or the like.

The display panel 110 displays an image according to a source signal and a gate signal that are generated by using data and a control signal received from the driver 130. Here, the display panel 110 includes a plurality of source lines and a plurality of gate lines, and each of the plurality of source lines and the plurality of gate lines may include at least one selected from a red light-emitting device, a green light-emitting device, and a blue light-emitting device.

The sensor 120 senses a leakage current of at least one of the plurality of source lines and the plurality of gate lines of the display panel 110. Here, the sensor 120 may sense variations in currents of the plurality of source lines and the plurality of gate lines of the display panel 110 to sense the leakage current.

The driver 130 is controlled by a timing controller, generates the source signal and the gate signal in response to a control signal provided from the timing controller, and provides the source signal and the gate signal to each of the red, green, and blue light-emitting devices through the sources line and the gate lines.

In particular, if the leakage current of the at least one of the plurality of source lines and the plurality of gate lines is higher than or equal to a preset value, the driver 130 may control an amount of power supplied to the line from which the leakage current higher than or equal to the preset value is sensed, to drive the display panel 110. Here, the driver 130 may determine a blanking interval at which the image is not displayed on the display panel 110 when the display panel 110 is driven through the timing controller and control the amount of power supplied to the line, from which the leakage current higher than or equal to the preset value is sensed, at the blanking interval to drive the display panel 110.

In detail, the driver 130 may determine a leakage current value of at least one of the plurality of source lines and the plurality of gate lines to determine a degradation characteristic of the display panel 110. In more detail, if a leakage current value of at least one line sensed through the sensor 120 is higher than or equal to the preset value, the driver 130 may determine the degradation characteristic of the display panel 110 according to an amount of the leakage current. In other words, if the leakage current value of at least one line sensed through the sensor 120 is higher than or equal to the preset value, the driver 130 may determine that the at least one line indicates a display degradation characteristic of a white pattern as the amount of the leakage current is large and indicates a display degradation characteristic of a black pattern as the amount of the leakage current is small.

The driver 130 may also differently control the amount of power according to the determined degradation characteristic of the display panel 110. In detail, if at least one line indicates the display degradation characteristic of the white pattern, the driver 130 may increase the amount of power supplied to the at least one line. Also, if the at least one line indicates the display degradation characteristic of the black pattern, the driver 130 may decrease the amount of power supplied to the at least one line.

If the leakage current of the at least one of the plurality of source lines and the plurality of gate lines sensed through the sensor 120 is lower than the preset value, the driver 130 may determine that the display panel 110 is normal and determine the amount of power according to the control signal received from the timing controller to supply the determined amount of power to each of the red, green, and blue light-emitting devices.

As described above, when the display panel 110 is driven, a leakage current of each line of the display panel 110 may be sensed to perform a refreshing operation in order to prevent a degradation phenomenon of the display panel 110.

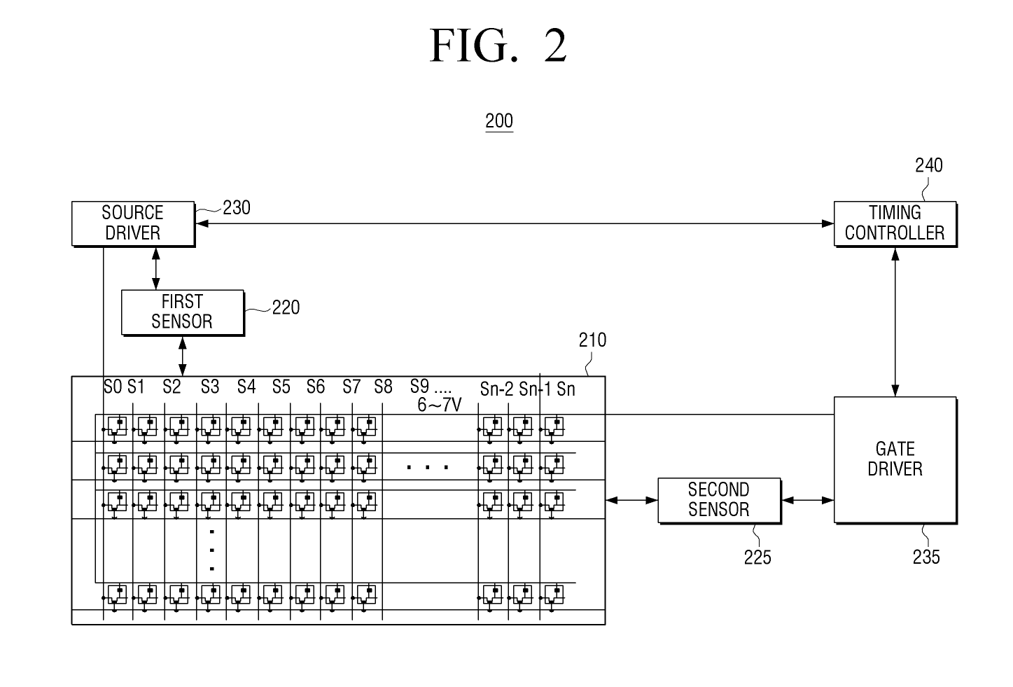

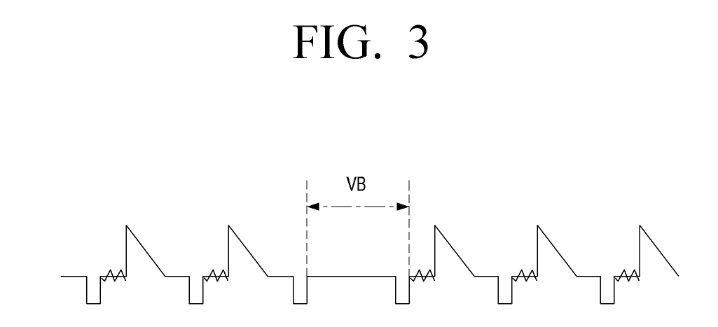

A display apparatus according to an exemplary embodiment will now be described in more detail with reference to FIGS. 2 and 3.

FIG. 2 is a view illustrating a detailed structure of a display apparatus 200 according to another exemplary embodiment. Referring to FIG. 2, the display apparatus 200 includes a display panel 210, a first sensor 220, a second sensor 225, a source driver 230, a gate driver 235, and a timing controller 240.

The display panel 210 is a part that displays an image according to a source signal and a gate signal and may be realized as various types of display panels such as an LCD panel, a PDP, an OLED panel, etc.

In particular, the display panel 210 includes a plurality of devices that respectively emit red (R), green (G), and blue (B) beams. The plurality of devices are provided with the source signal from the source driver 230 through source lines and are provided with the gate signal from the gate driver 235 through gate lines.

The first sensor 220 senses leakage currents of a plurality of source lines of the display panel 110. Here, the first sensor 220 may sense variations in currents of the plurality of source lines of the display panel 110 to sense the leakage currents of the plurality of source lines.

The second sensor 225 senses leakage currents of a plurality of gate lines of the display panel 110. Here, the second sensor 225 may sense variations in currents of the plurality of gate lines of the display panel 110 to sense the leakage currents of the plurality of gate lines.

The source driver 230 is controlled by the timing controller 240 and generates the source signal according to data and a control signal provided from the timing controller 240. The source driver 230 may provide the generated source signal to a corresponding source line. In particular, the source driver 230 may control supplies of power to devices of the source lines. Here, the source driver 230 may be realized as one driver, but this is only an exemplary embodiment. The source driver 230 may be realized as a plurality of drivers, i.e., as an integrated circuit (IC).

The number of source lines may be determined by a resolution of the display panel 210. For example, if the resolution of the display panel 210 is 1366×768, the number of source lines may be 1366×3, i.e., 4098.

In particular, the source driver 230 may determine whether a leakage current of at least one of the plurality of source lines is higher than or equal to a preset value. In detail, the source driver 230 may perform an analog-to-digital convert (ADC) with respect to amounts of currents of the plurality of source lines sensed by the first sensor 220, store the amounts of the currents, and determine whether a converted ADC value is higher than or equal to a preset value to determine whether a leakage current higher than or equal to the preset value is sensed.

If a leakage current of at least one of the plurality of source lines sensed through the first sensor 220 is higher than or equal to a preset value, the source driver 230 may determine a blanking interval at which an image is not displayed on the display panel 210 when the display panel 210 is driven through the timing controller 240. For example, as shown in FIG. 3, the source driver 230 may determine a blanking interval at which image data having a plurality of colors is not displayed but black image data is displayed, through an interface with the timing controller 240. In other words, if an amount of power is controlled at an interval at which an image having a plurality of colors is displayed on the display panel 110, a user may view a distorted image. Therefore, a refreshing operation may be performed by using a blanking interval at which an image is not displayed when the display panel 210 is driven, without interrupting viewing of the user.

If the blanking interval is determined, the source driver 230 may determine a degradation characteristic of the display panel 210 according to a leakage current value of a source line from which a leakage current higher than or equal to a preset value is sensed. In detail, if a leakage current of at least one line sensed through the first sensor 220 is higher than or equal to a preset value, the source driver 230 may determine that at least one source line indicates a display degradation characteristic of a white pattern as an amount of a leakage current of the source line is large and indicates a display degradation characteristics of a black pattern as the amount of the leakage current is small.

The source driver 230 may also control an amount of power supplied to the source line according to the determined degradation characteristic of the display panel 210. In detail, if the at least one source line indicates the display degradation characteristic of the white pattern, the source driver 230 may increase the amount of power supplied to the at least one source line. Also, if the at least one source line indicates the display degradation characteristic of the black pattern, the source driver 230 may decrease the amount of power supplied to the at least one source line. Therefore, a leakage current of each line of a display panel may be sensed at a blanking interval to perform a refreshing operation in order to prevent a degradation phenomenon of the display panel without interrupting viewing of the user.

A refreshing operation performed by the gate driver 235 is the same as that performed by the source driver 230, and thus repeated descriptions thereof are omitted.

The timing controller 240 controls the source driver 230 and the gate driver 235. In particular, the timing controller 240 may determine a blanking interval to provide information about the blanking interval to the source driver 230 and the gate driver 235.

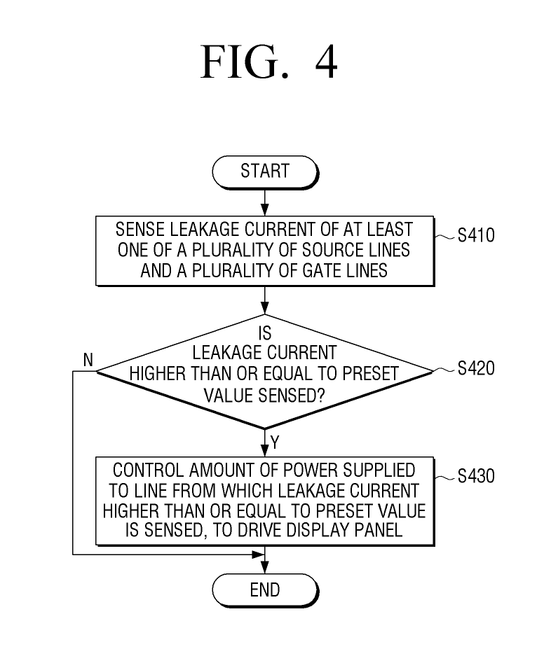

FIG. 4 is a flowchart illustrating a method of driving the display apparatus 100, according to an exemplary embodiment.

In operation S410, the display apparatus 100 senses a leakage current of at least one of a plurality of source lines and a plurality of gate lines. Here, the display apparatus 100 may sense variations in a current of at least one of the plurality of source lines and the plurality of gate lines to sense a leakage current of the at least one line.

In operation S420, the display apparatus 100 determines whether a leakage current higher than or equal to a preset value is sensed from the plurality of source lines and the plurality of gate lines. Here, a line from which the leakage current higher than or equal to the preset value is sensed may indicate a degradation characteristic of the display panel 110 of the display apparatus 100.

If the leakage current higher than or equal to the preset value is sensed in operation S420, the display apparatus 100 controls an amount of power supplied to the line, from which the leakage current higher than or equal to the preset value is sensed, to drive the display panel 110 in operation S430. In detail, the display apparatus 100 may determine the degradation characteristic of the display panel 110 according to a leakage current value and control an amount of power supplied to a source line according to the determined degradation characteristic of the display panel 110. In more detail, if the line indicates a display degradation characteristic of a white pattern, the display apparatus 100 may increase an amount of power supplied to the line from which the leakage current higher than or equal to the preset value is sensed. Also, if the line indicates a display degradation characteristic of a black pattern, the display apparatus 100 may decrease the amount of power supplied to the line from which the leakage current higher than or equal to the preset value is sensed.

In particular, the display apparatus 100 may perform operation S430 at a blanking interval of a display time. In detail, the display apparatus 100 may determine the blanking interval by using a timing controller and control an amount of power at the blanking interval to perform a refreshing operation. Therefore, a user may view an image by using a display panel of which display characteristic is improved, without interruption to viewing of the image.

A program code for performing a method of driving a display apparatus according to various exemplary embodiments as described above may be stored on various types of recording media. In detail, the program code may be stored on various types of computer-readable recording media such as a random access memory (RAM), a flash memory, a read only memory (ROM), an erasable programmable ROM (EPROM), an electrically erasable and programmable ROM (EEPROM), a register, a hard disc, a removable disc, a memory card, a universal serial bus (USB) memory, a CD-ROM, etc.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display panel comprising a plurality of source lines and a plurality of gate lines;
a sensor configured to sense a leakage current of at least one source line of the plurality of source lines or at least one gate line of the plurality of gate lines; and
a driver configured to, in response to the sensed leakage current being higher than or equal to a preset value, control an amount of power supplied to the line, from which the leakage current higher than or equal to the preset value is sensed, to drive the display panel.

2. The display apparatus of claim 1, further comprising:
a timing controller configured to control a display time of the display panel,
wherein the driver is further configured to determine a blanking interval at which an image is not displayed on the display panel when the display panel is driven through the timing controller and control the amount of power supplied to the line during the blanking interval.

3. The display apparatus of claim 2, wherein the driver is further configured to, in response to the sensed leakage current being higher than or equal to the preset value, determine a degradation characteristic of the display panel according to an amount of the sensed leakage current.

4. The display apparatus of claim 3, wherein the sensed leakage current indicates a display degradation characteristic of a white pattern when the amount of the leakage current is large and indicates a display degradation characteristic of a black pattern when the amount of the leakage current is small.

5. The display apparatus of claim 4, wherein the driver increases the amount of power supplied to the at least one line in response to the at least one line indicating the display degradation characteristic of the white pattern and decreases the amount of power supplied to the at least one line in response to the at least one line indicating the display degradation characteristic of the black pattern.

6. The display apparatus of claim 1, wherein the sensor is configured to sense the leakage current by sensing variations in a current of the at least one source line of the plurality of source lines or the at least one gate line of the plurality of gate lines.

7. The display apparatus of claim 1, wherein the driver is further configured to, in response to the sensed leakage current being lower than the preset value, determine that the display panel is normal.

8. A method of driving a display apparatus comprising a plurality of source lines and a plurality of gate lines, the method comprising:
sensing a leakage current of at least one source line of the plurality of source lines or at least one gate line of the plurality of gate lines; and
in response to the sensed leakage current being higher than or equal to a preset value, controlling an amount of power supplied to the line, from which the leakage current higher than or equal to the preset value is sensed, to drive a display panel.

9. The method of claim 8, further comprising:
determining a blanking interval, at which an image is not displayed on the display panel when the display panel is driven through a timing controller,
wherein the controlling the amount of power supplied to the line during the blanking interval.

10. The method of claim 9, wherein the driving of the display panel comprises:
in response to the sensed leakage current being higher than or equal to the preset value, determining a degradation characteristic of the display panel according to an amount of the sensed leakage current.

11. The method of claim 10, wherein the sensed leakage current indicates a display degradation characteristic of a white pattern when the amount of the leakage current is large and indicates a display degradation characteristic of a black pattern when the amount of the leakage current is small.

12. The method of claim 11, wherein the driving of the display panel comprises:
in response to the at least one line indicating the display degradation characteristic of the white pattern, increasing the amount of power supplied to the at least one line, and in response to the at least one line indicating the display degradation characteristic of the black pattern, decreasing the amount of power supplied to the at least one line.

13. The method of claim 8, wherein the sensing the leakage current comprises:
sensing variations in a current of at the least one source line of the plurality of source lines or the at least one gate line of the plurality of gate lines.

14. The method of claim 8, further comprising
determining, in response to the sensed leakage current being lower than the preset value, the display panel as being normal.

15. The display apparatus of claim 1, wherein the driver is further configured to control the amount of power supplied to the line, from which the leakage current higher than or equal to the preset value is sensed, to refresh the display panel.

16. The display apparatus of claim 15, wherein the driver is further configured to control the amount of power supplied to the line to refresh the display panel during a blanking interval.

17. The method of claim 8, wherein the controlling an amount of power supplied to the line, from which the leakage current higher than or equal to the preset value is sensed, comprises controlling a refreshing of the display panel.

18. The method of claim 17, wherein the controlling a refreshing of the display panel occurs during a blanking interval.

19. A display apparatus comprising:
a display panel comprising a source line and a gate line;
a sensor configured to sense a leakage current of the source line and the gate line; and
a driver configured to, in response to the sensor sensing the leakage current higher than a preset value from the sensed source line and the gate line, refresh the line from which the leakage current was sensed.

20. The display apparatus of claim 19, wherein the driver is further configured to determine a blanking interval of the display panel and refresh the line from which the leakage current was sensed during the blanking interval.
